(19) United States
(12) Patent Application Publication
(10) Pub. No.: US 2007/0169693 A1
(43) Pub. Date: Jul. 26, 2007

(54) Curtain coater with laterally adjustable edge splitting

(76) Inventors: Peter Schweizer, Wunnewil (CH); Ferdinand Krebs, Wabern (CH)

Correspondence Address: RATNERPRESTIA, P O BOX 980, VALLEY FORGE, PA, 19482-0980, US

(21) Appl. No.: 11/639,535

(22) Filed: Dec. 15, 2006

(30) Foreign Application Priority Data
Dec. 15, 2005 (DE) 10 2005 059 966.4

(51) Int. Cl. B05C 3/02

(52) U.S. Cl. 118/413; 118/412

(57) ABSTRACT

A curtain coater for coating a moved substrate , with a nozzle system for creating a curtain comprising at least one coating liquid falling onto the substrate ; a side edge splitting device which splits off an edge of the falling curtain at an outer end after leaving the nozzle system and thus bounds its width; and a curtain guide structure, with a guide which guides the curtain at the side, mounted with the side edge splitting device such that the side edge splitting device and the curtain guide structure are adjustable as a unit in the width direction relative to the nozzle system.

This application claims priority to German Patent Appln. No. 10 2005 059 966.4 filed Dec. 15, 2005, which is incorporated in its entirety by reference herein.

### BACKGROUND OF INVENTION

1. Technical Field.

The invention relates to a device for curtain coating a moved substrate, preferably a flexible, endlessly conveyed web.

2. Description of the Related Art.

Curtain coating is one of many methods used to coat flexible, endless webs with a thin film of liquid. The method is suitable for applying a coating of a single liquid or several coatings of different liquids simultaneously. The curtain coating method has been known and studied for many years. Miyamoto and Katagiri, Curtain Coating, give a detailed description in Liquid Film Coating, Chapter 11c , Chapman & Hall, New York 1997. In industrial applications, the curtain is either wider or narrower than the web to be coated. Surface tensions occur if a liquid curtain is not guided along the line where it drops. This leads to a loss of control over the curtain width and hence over the pouring width at the point where the curtain makes contact with the web to be coated. For these reasons, a non-guided curtain is highly practical in industrial applications if the curtain is substantially wider than the web to be coated and consists of only one liquid. In this case, the surplus liquid can be collected and used gain. In all other applications, especially if the curtain comprises several liquid coatings, it is of practical advantage to guide the curtain vertically at both sides in order to keep the curtain width constant and minimise liquid losses. It is of advantage to use a boundary system for guided liquid curtains.

A stable liquid curtain is desired to implement the curtain coating method successfully. A stable curtain is one which is not susceptible to internal and external disruptions, i.e. it can not be permanently destroyed by disruptions. Theoretical and experimental tests of the stability of liquid curtains are discussed by Brown, D. R. in A study of the behaviour of a thin sheet of moving liquid, J. Fluid Mechanics 10, pages 297-305, and by Taylor, G. I., 1959, in The dynamics of thin sheets of fluid, part III: Disintegration of fluid sheets, Proc. Roy. Soc. London A, pages 253-313.

Brown defined the following stability criterion for liquid curtains. The curtain is stable if the speed at which it falls is higher than the speed at which disruptions spread within the curtain. Under this condition, disruptions are not able to spread in the direction opposite the downwardly directed falling movement but are entrained downwards and at most, can therefore tear open the curtain locally and temporarily but not catastrophically.

The following factors are also known to be conductive to the stability of liquid curtains: long curtains, thick curtains, low surface tension of the liquid, high density of the liquid, high dropping speed, high volume flow in the curtain. Similarly, it may be concluded that curtain stability is at risk or may be completely lost if the flow within the curtain does not exhibit the above properties. Curtain stability is already at risk if the properties outlined above do not exist even locally, for example along a curtain lateral guide.

A slotted nozzle or a cascade nozzle may be used in particular to create a liquid curtain, such as described by Miyamoto and Katagiri. In the case of a slotted nozzle, the curtain is formed directly at the outlet of the nozzle slot. In the case of a cascade nozzle, on the other hand, after leaving the nozzle slot, the liquid initially flows in the form of a single or multi-layered liquid film on the nozzle surface as far as the nozzle lip. Not until it reaches the nozzle lip does the film flow change into a curtain flow. To ensure that the film flow on the nozzle surface remains well defined in terms of its width, it must be laterally guided by means of a nozzle lateral boundary. If the liquid is laterally bounded by a wall at a free surface, depending on the wetting properties between the liquid and wall material, the wetting line, due to capillary forces, will be disposed either above the liquid surface if wetting is good or below it if wetting is poor, as described by Weinstein, S. J. and Palmer A. J. in Capillary hydrodynamics and interfacial phenomena, Chapter 2, in Liquid Film Coating, Chapman & Hall, New York, 1997, for example. The shape of the liquid surface therefore changes along the boundary. The changes may be particularly pronounced as the liquid flows along the side boundary. This is demonstrated by Schweizer, P. M., 1988, Visualisation of coating flows, J. Fluid Mechanics 193, pages 285-302, for example.

Curtain coaters, and in particular their nozzle side edges, are described in patent specifications DE 30 37 612 C2 and WO 94/08272, for example.

The dropping curve of the curtain is largely dependent on the type of nozzle used to create the curtain. If a slotted nozzle is used, the curtain falls essentially vertically, in the extension of the nozzle slot, especially if the curtain comprises a single liquid. If a cascade nozzle is used to create the curtain, on the other hand, a non-symmetrical flow field results in the area around the nozzle lip, which causes the curtain curve to be deflected from the vertical. In particular, the curtain curves backwards underneath the nozzle lip, which is referred to as the “teapot effect” (Kistler, S. F. and Scriven, L. E., 1994, The tea-pot effect: sheet forming flows with deflection, wetting and hysteresis, J. Fluid Mechanics 263, pages 19-62). Allowance must be made for this effect in the design of the curtain side boundary.

Patent specification DE 10 2004 016 923 A1 discloses a curtain coater for the coating of a moving substrate, comprising a nozzle device, for the generation of a curtain dropping onto the substrate, made up of at least one coating fluid and a curtain guide structure with a guide surface, which laterally guides the curtain, whereby the guide surface is convex to the curtain along a width exceeding the depth of the curtain when measured transversely.

Patent specification EP 0 977 636 B1 discloses a device for applying dispersions to a material web, whereby adjustable separator elements which can be introduced into the curtain are provided downstream of a lateral guide and directly above the web on either side to enable coating widths to be adjusted.

### SUMMARY OF THE INVENTION

An objective of the invention is to propose an optimised way of adjusting the width of a curtain coater of the generic type.

The curtain coater proposed by the invention as a means of coating a moved substrate comprises:
a) a nozzle system for creating a curtain of at least one coating liquid which drops onto the substrate;
b) at least one side edge splitting device, which splits off an edge at an outer end of the falling curtain on leaving the nozzle system and thus bounds a width; and
c) a curtain guide structure adjoining the side edge splitting device with a guide which guides the curtain at the side,

and its side edge splitting device can be adjusted in the width direction together with the curtain guide structure.

In other words, the edge of the falling curtain is not split off from outside separately and independently of the curtain guide, as is the case with the prior art known from EP 0 977 636 B1, but instead, the edge splitting and guiding operations are undertaken in conjunction with one another, including within variably adjustable, split-off widths for the curtain. A major advantage of this approach, already, is that for every set curtain width, the guide is simultaneously set in an optimal position. To this end, the side edge splitting device and the curtain guide structure can be adjusted together across identical distances; however, this still leaves open the possibility of adjusting the curtain guide structure whenever the side edge splitting device is adjusted but optionally by a different degree if this is conductive to obtaining optimum guiding of the curtain.

The invention therefore advantageously avoids problems which occur in situations where only side edge splitting devices are separately adjustable, because separate operation of the side edge splitting devices can in turn lead to flow situations which place at risk or restrict the stability of the coating curtain portion. In this sense, the present invention should also be construed as a method whereby the physical features of the curtain coater described in this document may be employed to produce an optimal coating.

Other advantages of the solution proposed by the invention relate to a better discharge system for the edges split off from the curtain on one or both sides and the fact that an interfacial liquid is able to reach the substrate more quickly at the contact point. There is also greater freedom in terms of the design of the side boundary; it must not be flat at the bottom end (of the curtain guide structure/guide).

In a preferred embodiment of the invention, the side edge splitting device is disposed in the flow path of the coating liquid downstream of the nozzle system and upstream of the curtain guide structure and the curtain guide structure therefore follows the edge splitting device functionally, which means that the curtain is always sufficiently well guided, thereby imparting stability to it.

The side edge splitting device may be adjusted by means of a rail system and this rail system may be disposed alongside the nozzle system in particular. This offers an option whereby the side edge splitting device and/or the shape guiding structure can be slidably and fixably connected to the rail system by means of a rail operating system.

The adjustment options can be achieved in various ways. If the curtain is to be set to a specific width setting that will remain constant for a long period of time, a manual adjustment or sliding action would be perfectly conceivable in such situations. A motor-driven adjustment would be suitable for systems requiring different coating widths more often, on the other hand. Likewise, the side edge splitting device may be fixed mechanically or on a motor-driven basis, depending on requirements and the frequency of adjustment operations.

The side edge splitting device may be of the type with a separator edge and a catchment and discharge system for the coating liquid split off at the outer end.

The nozzle system of the curtain coater proposed by the invention may comprise the following components: a nozzle surface inclined with respect to the horizontal; an outlet orifice through which the coating liquid can be directed to the nozzle surface so that the coating liquid forms a downwardly flowing film on the nozzle surface; a nozzle lip, which forms a downstream end of the nozzle surface; and a nozzle boundary for laterally bounding the film flow. Accordingly, in one embodiment of the invention, the nozzle side boundary may also be adjustable in the width direction and this adjustment may be functionally incorporated with the adjustment function of the side edge splitting device/curtain guide structure in order to optimise forming properties and hence the coating.

### BRIEF DESCRIPTION OF THE DRAWINGS

Examples of embodiments of the invention will be explained with reference to the drawings. Features which become apparent from this description and in particular also those disclosed in connection with the examples of embodiments may be construed as individual features per se, which may be used in any combination of features and further complement the explanations given above. Of the drawings:

FIG. 1 is a side cross-sectional view of a curtain coater with a nozzle system in the form of a slotted nozzle;

FIG. 2 is a side cross-sectional view of a curtain coater with a nozzle system in the form of a cascade nozzle;

FIG. 3 is a perspective view of a portion of a curtain coater proposed by the invention with an adjustable side edge splitting device/curtain guide structure;

FIG. 4 is a perspective view of a guide structure and the rail by means of which it is mounted on the nozzle system; and

FIG. 5 is a side elevation view of the rail fixing for the guide structure from the other side and incorporating its individual parts.

### DETAILED DESCRIPTION OF THE PREFERRED EMBODIMENTS

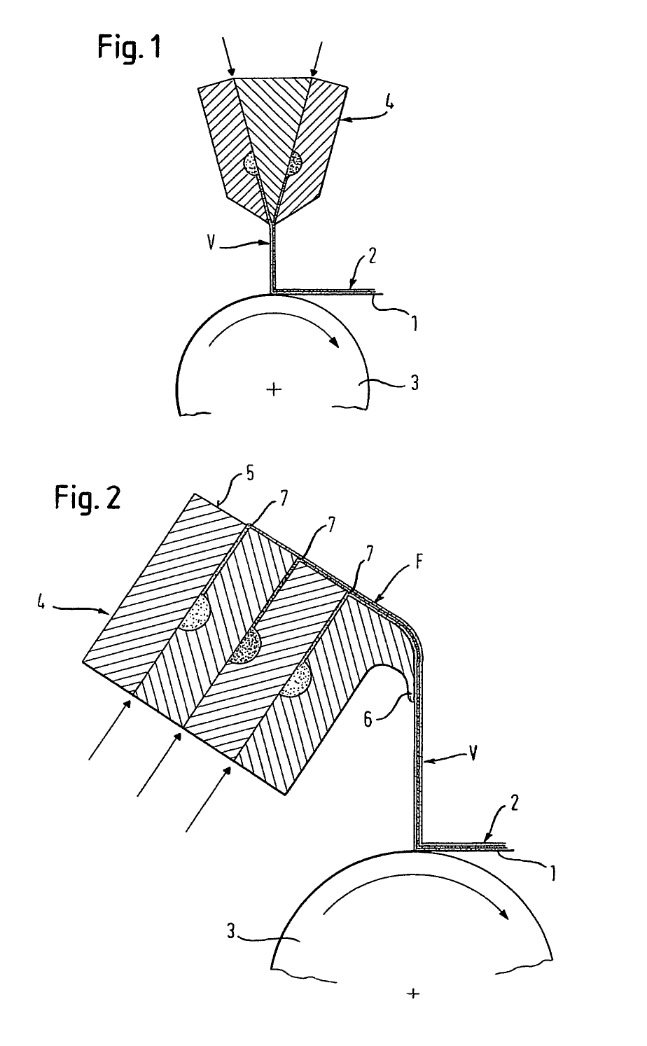

FIG. 1 illustrates a curtain coater with a nozzle system 4 disposed at a slight vertical distance above a roll 3. The roll 3 serves as a deflecting mechanism or, in more general terms, a support mechanism, for a substrate 1 to be coated, which is conveyed in a loop round the roll 3. The substrate 1 is an endlessly conveyed flexible web. The nozzle system 4 is a slotted nozzle, in which separate inlets for several different coating fluids are provided, of which there are two in the embodiment described as an example. The inlets converge in a nozzle outlet orifice at a bottom end of the nozzle system 4 facing the substrate 1. The outlet orifice extends in a slot shape, transversely to the direction in which the substrate 1 is conveyed, across a width which is bigger than the coating width of the product to be obtained from the substrate 1 and coating 2. In principle, the width of such an outlet orifice may also be shorter than the coating width to be produced. The two coating liquids are free falling as they leave the outlet orifice of the nozzle system 4 and form a two-layered liquid curtain V. The nozzle system 4 is disposed relative to the roll 3 so that the curtain V spans a vertical plane with a rotation axis of the roll 3, provided it is not disrupted.

FIG. 2 illustrates a curtain coater with a nozzle system 4 in the form of a cascade nozzle. It has a nozzle surface 5 inclined with respect to the horizontal so that a coating liquid delivered to the nozzle surface 5 flows downwards as far as a nozzle lip 6 forming the downstream end of the nozzle surface 5 and flows beyond the nozzle lip 6, merging into the free falling curtain V. Several different coating liquids corresponding in number to outlet orifices 7 are fed to the nozzle surface 5 via the outlet orifices 7 and form a multi-layered film flow F on the nozzle surface 5 in a known manner, which flows over the nozzle lip 6 down into the curtain V. The outlet orifices 7 are slot shaped and extend transversely across the width of the nozzle surface 5. At its upstream portion extending across the outlet orifices 7, the nozzle surface 5 is flat, i.e. it forms an oblique plane there. In an adjoining, downstream portion, the nozzle surface 5 is curved and its inclination gradually increases, resulting in a continuous transition to the downstream end of the nozzle lip 6.

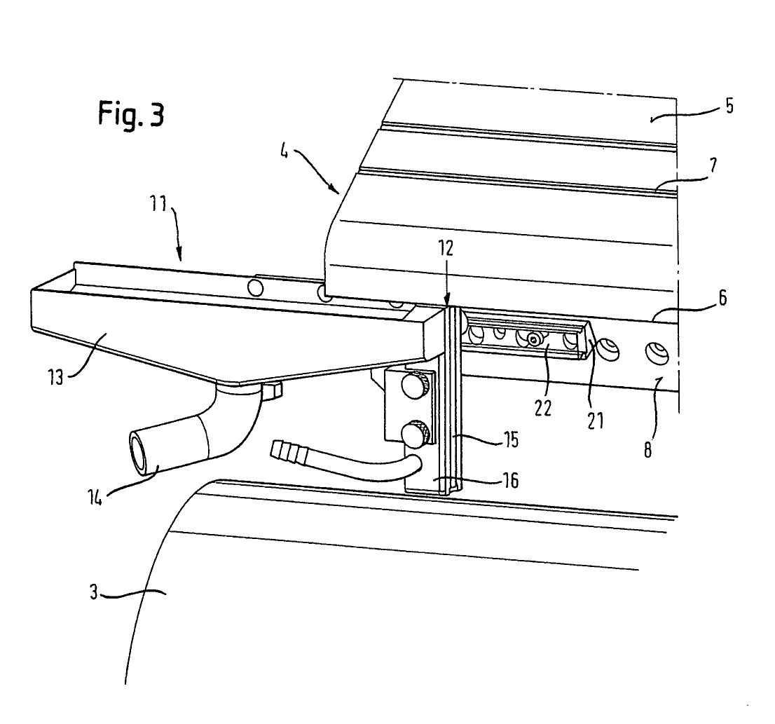

The perspective view shown in FIG. 3 provides an overall view of the curtain coater proposed by the invention. The nozzle system 4 illustrated in FIG. 3 is also a cascade nozzle and in order to provide a better overall view, the curtain has been omitted in this instance. Underneath the nozzle lip 6 (bottom edge) of the nozzle system 4, the side edge splitting device 11 projects inwards from the left-hand side. It has a separator edge 12, which splits the curtain falling from the nozzle lip 6 into two parts, namely a coating curtain part falling to the right hand side of the middle of the nozzle surface in the drawing and a separate curtain part to the left of the edge 12 which drops into the catchment and discharge tray 13 and is discharged via the pipe 14.

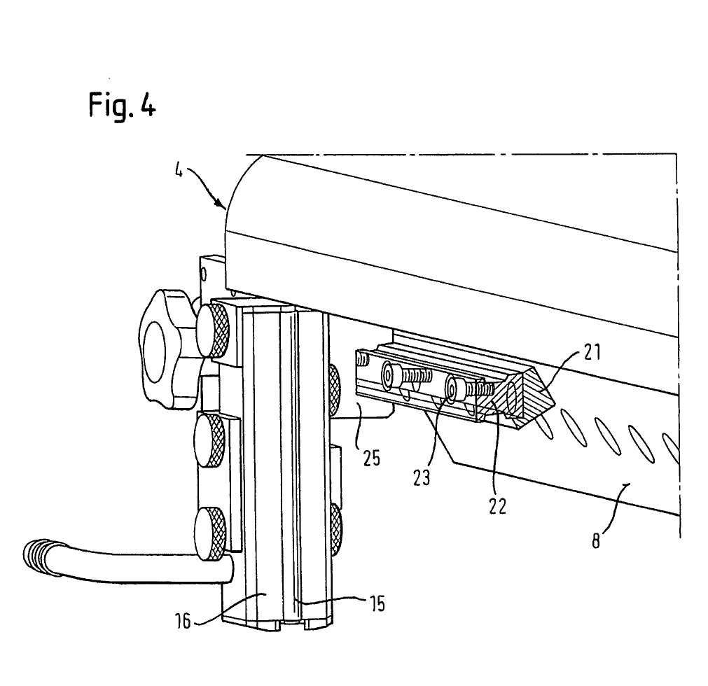

The continuously flowing curtain to the right of the separator edge 12 is laterally guided by means of the curtain guide structure 16 incorporating the guide 15 before it makes contact with a substrate conveyed on the roll 3. FIG. 4 provides a clearer illustration of the guide 15 of the curtain guide structure 16, which guide 15 is provided in the form of a convex guide surface to enable the dropping line of the curtain to be exactly defined, minimise tension in the curtain and reduce interfacial effects.

For the purpose of the invention, the side edge splitting device 11 and the curtain guide structure 16 constitute a unit in the sense that they can be adjusted together with one another in the width direction, and this width adjustment function is possible due to a rail 21 mounted on the bottom oblique surface 8 of the nozzle, which may be seen in FIGS. 3, 4 and 5. The side edge splitting device 11 can be adjusted in conjunction with the curtain guide structure with the aid of this rail, thereby enabling the width of the curtain to be set and ensuring that the rest of the curtain split off is efficiently fed away and the coating curtain is efficiently applied to the substrate.

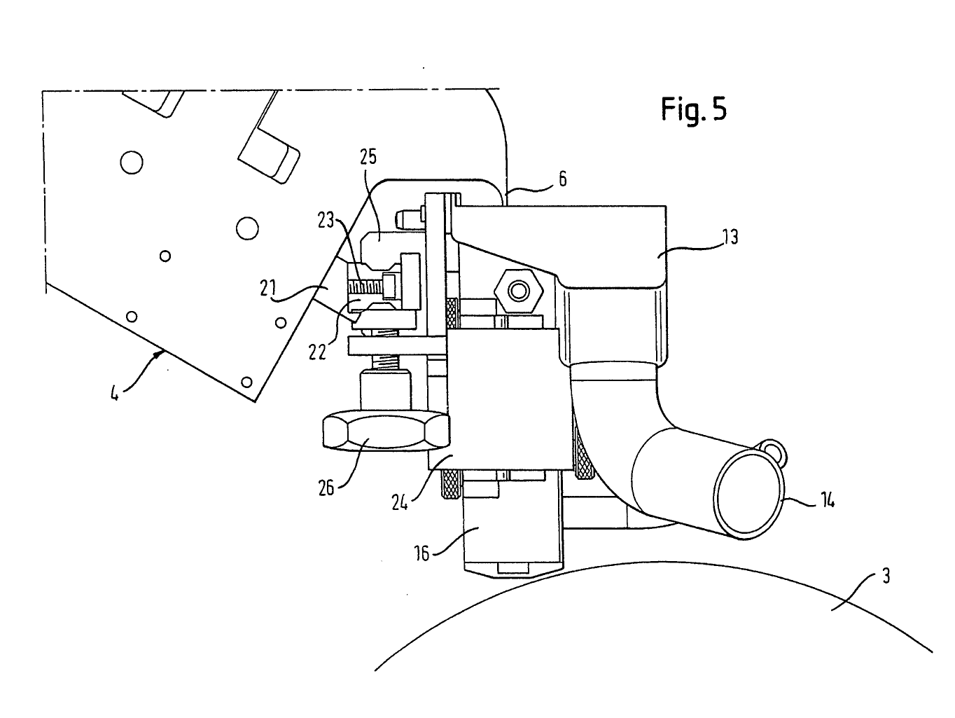

The rail 21 on the bottom nozzle surface 8 supports a guide element 22, which is illustrated as a transparent component in FIGS. 3, 4 and 5. The guide element 22 constitutes the “transition” as it were between the rail 21 and a clamp 25, already provided on the side of the curtain guide structure 16 as a retaining part. The guide element 22 is secured to the rail 21 by individual countersunk screws 23 (with an internal hexagon head) spaced at a distance apart from one another. The other components to be described may best be seen from FIG. 5. The clamp 25 and the handwheel screw 26 engage with the guide element 22 from above or from below and thus establish a solid connection of the support structure 24 to the guide element 22. The support structure 24 is in turn secured to the curtain guide structure 16 by means of knurled screws, which are externally visible in FIGS. 3, 4 and 5, and the curtain guide structure 16 and naturally also the adjoining side edge splitting device 11 are assembled and secured in the following sequence order: curtain guide structure 16, support structure 24, hand screw 26 and counter clamp 25, guide element 22, fixing screws 23, rail 21 and surface 8 on the nozzle 4.

The advantage of this assembly and fixing system is that it offers high flexibility. Firstly, the guide element 22 secured by means of the hand screw 26 can be easily loosened and tightened again, thereby providing a simple way of adjusting the curtain width. The knurled screws used to mount the curtain guide structure 16 on the support structure 24 can in turn likewise be easily loosened, thereby providing an easy way of replacing the curtain guide structure 16 and an easy way of dismantling it for cleaning and maintenance purposes.

All in all, the embodiment illustrated in FIGS. 3 to 5 enables the width of the curtain to be adjusted in a simple and reliable way, although other fixing, connecting and adjusting means would naturally also be perfectly conceivable within the context of the present invention, for example a motor-driven fixing and sliding system or a stepped adjustment function provided with stops for setting up special curtain widths.

1. A curtain coater for coating a moved substrate , comprising:
a nozzle system for creating a curtain comprising at least one coating liquid falling onto the substrate;
a side edge splitting device which splits off an edge of the falling curtain at an outer end after leaving the nozzle system and thus bounds its width and defines a curtain side; and
a curtain guide structure, with a guide which guides the curtain at the side, mounted with the side edge splitting device such that the side edge splitting device and the curtain guide structure are adjustable as a unit in the width direction relative to the nozzle system.

2. The curtain coater as claimed in claim 1, wherein the side edge splitting device is disposed in the flow path of the coating liquid downstream of the nozzle system and upstream of the curtain guide structure.

3. The curtain coater as claimed in claim 1, wherein the side edge splitting device is adjustable by means of a rail system disposed on the nozzle system .

4. The curtain coater as claimed in claim 3, wherein the side edge splitting device, the curtain guide structure, or a combination thereof are adjustable by means of a rail operating system to which they are fixedly connected.

5. The curtain coater as claimed in claim 1, wherein the side edge splitting device is slidably adjustable either manually or on a motorised basis.

6. The curtain coater as claimed in claim 1, wherein the side edge splitting device is secured mechanically or by motor means.

7. The curtain coater as claimed in claim 1, wherein the side edge splitting device has a separator edge and a catchment and discharge system for the coating liquid split off at the outer end.

8. The curtain coater as claimed in claim 1 wherein the nozzle system comprises:
a nozzle surface inclined with respect to the horizontal;
an outlet orifice through which the coating liquid can be directed to the nozzle surface so that it forms a downwardly flowing film on the nozzle surface;
a nozzle lip forming a downstream end of the nozzle surface ;and
a nozzle side boundary for laterally bounding the film flow.

9. The curtain coater as claimed in claim 8, wherein the nozzle side boundary is adjustable in the width direction.
